(19) United States
(12) Patent Application Publication
(10) Pub. No.: US 2006/0027782 A1
(43) Pub. Date: Feb. 9, 2006

(54) Coolant based on azole derivatives containing 1,3-propanediol for fuel cell cooling systems

(76) Inventors: Bernd Wenderoth, Birkenau (DE); Birgit Flaig, Beindersheim (DE)

Correspondence Address: NIXON & VANDERHYE, PC, 901 NORTH GLEBE ROAD, 11TH FLOOR, ARLINGTON, VA, 22203, US

(21) Appl. No.: 10/536,806

(22) PCT Filed: Dec. 3, 2003
(86) PCT No.: PCT/EP03/13633

§ 371 Date: May 27, 2005

(30) Foreign Application Priority Data
Dec. 12, 2002 (DE) 102 58 385.4

(51) Int. Cl. C09K 5/00

(52) U.S. Cl. 252/71

(57) ABSTRACT

Antifreeze concentrates for cooling systems in fuel cell drives, from which ready-to-use aqueous coolant compositions having a conductivity of not more than 50 μS/cm result, based on 1,3-propanediol or mixtures of 1,3-propanediol with alkylene glycols and/or derivatives thereof, containing one or more five-membered heterocyclic compounds (azole derivatives) having 2 or 3 hetero atoms from the group consisting of nitrogen and sulfur, which contain no sulfur atom or not more than one sulfur atom and which may carry an aromatic or saturated six-membered fused moiety.

The present invention relates to coolants for cooling systems in fuel cell drives, in particular for motor vehicles, based on 1,3-propanediol or mixtures of 1,3-propanediol with alkylene glycols and/or derivatives thereof, which contain special azole derivatives as corrosion inhibitors.

Fuel cells for mobile use in motor vehicles must also be capable of being operated at low outdoor temperatures down to about −40° C. A coolant circulation protected from freezing is therefore indispensable.

The use of conventional radiator antifreezes used in internal combustion engines would not be possible in the case of fuel cells without complete electrical insulation of the cooling channels, since, owing to the salts and ionizable compounds contained therein as corrosion inhibitors, these compositions have an excessively high electrical conductivity, which would adversely affect the function of the fuel cell.

DE-A 198 02 490 (1) describes fuel cells having a cooling circulation which is protected from freezing and in which the coolant used is a paraffinic isomer mixture having a pour point of less than −40° C. However, a disadvantage is the flammability of such a coolant.

EP-A 1 009 050 (2) discloses a fuel cell system for automobiles, in which air is used as a cooling medium. However, a disadvantage here is that air is known to be a poorer heat conductor than a liquid cooling medium.

WO 00/17951 (3) describes a cooling system for fuel cells, in which the coolant used is a pure monoethylene glycol/water mixture in the ratio 1:1 without additives. Since, owing to the absence of corrosion inhibitors, there would be no corrosion protection at all with respect to the metals present in the cooling system, the cooling circulation contains an ion exchange unit in order to maintain the purity of the coolant and to ensure a low specific conductivity for a relatively long time, with the result that short-circuits and corrosion are prevented. Anionic resins, for example of the strongly alkaline hydroxyl type, and cationic resins, for example based on sulfo groups, are mentioned as suitable ion exchangers, and other filtration units, for example active carbon filters, are also mentioned.

The structure and the mode of operation of a fuel cell for automobiles, in particular of a fuel cell having an electron-conducting electrolyte membrane (PEM fuel cell, polymer electrolyte membrane fuel cell) is described by way of example in (3), aluminum being the preferred metal component in the cooling circulation (radiator).

WO 02/055630 (4) describes coolants for cooling systems in fuel cell drives which are based on glycol and contain ortho-silicic esters as corrosion inhibitors.

WO 02/073727 (5) describes nontoxic fuel cell coolants based on 1,3-propanediol in water without additives.

The use of azole derivatives such as benzimidazole, benzotriazole or tolutriazole, as corrosion inhibitors in radiator antifreezes for conventional internal combustion engines operated with gasoline or diesel fuel has long been known, for example from: G. Reinhard et al., Aktiver Korrosionsschutz in wässrigen Medien, pages 87-98, expert-Verlag 1995 (ISBN 3-8169-1265-6).

The use of such azole derivatives in coolants based on alkylene glycols or derivatives thereof for cooling systems in fuel cell drives is described in the German Patent Application having the application number 101 28 530.2 (6).

A principal problem in the case of cooling systems in fuel cell drives is the maintenance of a low electrical conductivity of the coolant, in order to ensure reliable and trouble-free operation of the fuel cell and permanently to prevent short-circuits and corrosion.

Surprisingly, it has been found that the duration of a low electrical conductivity in a cooling system based on 1,3-propanediol or mixtures of 1,3-propanediol with alkylene glycols and/or derivatives thereof, also and in particular when it contains an integrated ion exchanger according to (3), can be substantially increased by adding small amounts of azole derivatives. In practice, this has the advantage that the time intervals between two coolant changes in fuel cell drives can be further extended, which is of interest in particular in the automotive sector.

Accordingly, antifreeze concentrates for cooling systems in fuel cell drives have been found from which ready-to-use aqueous coolant compositions having a conductivity of not more than 50 μS/cm result, based on 1,3-propanediol or mixtures of 1,3-propanediol with alkylene glycols and/or derivatives thereof, which contain one or more five-membered heterocyclic compounds (azole derivatives) having 2 or 3 hetero atoms from the group consisting of nitrogen and sulfur, which contain no sulfur atom or not more than one sulfur atom and which may carry an aromatic or saturated six-membered fused moiety.

Preferred antifreeze concentrates here are those which contain altogether from 0.05 to 5, in particular from 0.075 to 2.5, especially from 0.1 to 1, % by weight of said azole derivatives.

These five-membered heterocyclic compounds (azole derivatives) usually contain two nitrogen atoms and no sulfur atom, 3 nitrogen atoms and no sulfur atom or one nitrogen atom and one sulfur atom as hetero atoms.

Preferred groups of said azole derivatives are fused imidazoles and fused 1,2,3-triazoles of the formula (I) or (II) 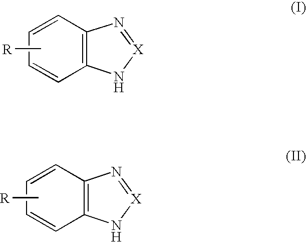
where R is hydrogen or a C₁— to C₁₀-alkyl radical, in particular methyl or ethyl, and X is a nitrogen atom or a C—H group. Typical examples of the azole derivatives of the formula (I) are benzimidazole (X═C—H, R═H), benzotriazole (X═N, R═H) and tolutriazole (X═N, R═CH₃). A typical example of an azole derivative of the formula (II) is hydrogenated 1,2,3-tolutriazole (X═N, R═CH₃).

A further preferred group of said azole derivatives are benzothiazoles of the formula (III) 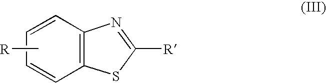
where R has the abovementioned meaning and R′ is hydrogen, a C₁— to C₁₀-alkyl radical, in particular methyl or ethyl, or in particular the mercapto group (—SH). A typical example of an azole derivative of the formula (III) is 2-mercaptobenzothiazole.

Furthermore, nonfused azole derivatives of the formula (IV) 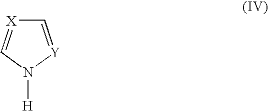
where X and Y together are two nitrogen atoms or one nitrogen atom and one C—H group, for example 1H-1,2,4-triazole (X═Y═N) or imidazole (X═N, Y═C—H), are preferred.

Benzimidazole, benzotriazole, tolutriazole, hydrogenated tolutriazole, 1H-1,2,4-triazole or mixtures thereof are very particularly preferred as azole derivatives for the present invention.

Said azole derivatives are commercially available or can be prepared by conventional methods. Hydrogenated benzotriazoles, such as hydrogenated tolutriazole, are likewise obtainable according to DE-A 19 48 794 (7) and are also commercially available.

In addition to said azole derivatives, the novel antifreeze concentrates preferably additionally contain ortho-silicic esters, as described in (4). Typical examples of such ortho-silicic esters are tetraalkoxysilanes, such as tetraethoxysilane. Antifreeze concentrates, in particular those containing altogether from 0.05 to 5% by weight of said azole derivatives, from which ready-to-use aqueous coolant compositions having a silicon content of from 2 to 2 000, in particular from 25 to 500, ppm by weight result, are preferred here.

Ready-to-use aqueous coolant compositions having a conductivity of not more than 50 μS/cm, which substantially comprise

(a) from 10 to 90% by weight of 1,3-propanediol or mixtures of 1,3-propanediol with alkylene glycols and/or derivatives thereof,

(b) from 90 to 10% by weight of water,

(c) from 0.005 to 5, in particular from 0.0075 to 2.5, especially from 0.01 to 1, % by weight of said azole derivatives and

(d) if required, ortho-silicic esters,

can be prepared from the novel antifreeze concentrates by dilution with ion-free water. The sum of all components here is 100% by weight.

The present invention therefore also relates to ready-to-use aqueous coolant compositions for cooling systems in fuel cell drives, which substantially comprise

(a) from 10 to 90% by weight of 1,3-propanediol or mixtures of 1,3-propanediol with alkylene glycols and/or derivatives thereof,

(b) from 90 to 10% by weight of water,

(c) from 0.005 to 5% by weight, in particular from 0.0075 to 2.5, especially from 0.01 to 1, % by weight of said azole derivatives and

(d) if required, ortho-silicic esters

and which are obtainable by dilution of said antifreeze concentrates with ion-free water. The sum of all components here is 100% by weight.

The novel ready-to-use aqueous coolant compositions have an initial electrical conductivity of not more than 50, in particular 25, preferably 10, especially 5, μS/cm or less. The conductivity is kept at this low level during continuous operation of the fuel cell drive over several weeks or months, in particular if a cooling system having an integrated ion exchanger is used in the fuel cell drive.

The pH of the novel ready-to-use aqueous coolant composition decreases substantially more slowly over the duration of operation than in the case of cooling liquids to which said azole derivatives have not been added. The pH is usually from 4.5 to 7 in the case of fresh novel coolant compositions and generally decreases to 3.5 in continuous operation. The ion-free water used for the dilution may be pure distilled or bidistilled water or water demineralized, for example, by ion exchange.

The preferred weight ratio of 1,3-propanediol or mixtures of 1,3-propanediol with alkylene glycols and/or derivatives thereof to water in the ready-to-use aqueous coolant compositions is from 20:80 to 80:20, in particular from 25:75 to 75:25, preferably from 65:35 to 35:65, especially from 60:40 to 40:60.

It is also possible to use mixtures of 1,3-propanediol with alkylene glycol components and/or derivatives thereof, in particular with monoethylene glycol, but also with monopropylene glycol (=1,2-propanediol), polyglycols, glycol ethers or glycerol. Those mixtures containing more than 50, in particular more than 80, especially more than 95, % by weight of 1,3-propanediol are preferred here.

The novel antifreeze concentrates themselves, from which the ready-to-use aqueous coolant compositions described result, can be prepared by dissolving said azole derivatives in 1,3-propanediol or mixtures of 1,3-propanediol with alkylene glycols and/or derivatives thereof, which can be used in anhydrous form or with a low water content (up to about 10, in particular up to 5, % by weight).

The present invention also relates to the use of five-membered heterocyclic compounds (azole derivatives) having 2 or 3 hetero atoms from the group consisting of nitrogen and sulfur, which contain no sulfur atom or not more than one sulfur atom and which may carry an aromatic or saturated six-membered fused moiety, for the preparation of antifreeze concentrates for cooling systems in fuel cell drives, in particular for motor vehicles, based on 1,3-propanediol or mixtures of 1,3-propanediol with alkylene glycols and/or derivatives thereof.

The present invention furthermore relates to the use of these antifreeze concentrates for the preparation of ready-to-use aqueous coolant compositions having a conductivity of not more than 50 μS/cm for cooling systems in fuel cell drives, in particular for motor vehicles.

The novel coolant compositions can also be used in fuel cell units according to WO 02/063707 (8) or according to the German Patent Application having the application number 102 01 276.8 (9), in which the cooling medium is additionally demineralized electrochemically or by means of a liquid deionizing agent to prevent corrosion.

### EXAMPLES

The examples which follow illustrate the invention without restricting it. The novel coolant compositions were subjected to the test described below with regard to their suitability for cooling systems for fuel cell drives:

Description of Test:

Five aluminum test metals (vacuum-soldered aluminum, designation: EN-AW 3005, braze clad on one side with 10% by weight of EN-AW 4045; dimensions: 58×26×0.35 mm, having a hole of 7 mm diameter) were weighed, nonconductively connected by means of a plastics bolt with nut and Teflon washers and placed on two Teflon stands in a 1 1 beaker having a ground glass joint and glass cover. 1000 ml of test liquid were then introduced. The beaker was closed air-tight with the glass cover and heated to 88° C., and the liquid was vigorously stirred using a magnetic stirrer. The electrical conductivity was measured at the beginning of the test and at weekly intervals using a previously taken liquid sample at room temperature (conductivity meter LF 530 from WTW/Weilheim). After the end of the test, the aluminum samples were visually assessed and, after pickling with aqueous chromic acid/phosphoric acid according to ASTM D 1384-94, were evaluated gravimetrically.

The results are shown in table 1. They show that, even after a test duration of 28 days, virtually no increase in the electrical conductivity was observable in the novel examples 1 and 2 within the standard deviation since the beginning of the test; the values were still below 5 μS/cm and were thus at least equivalent to the formulations according to (6).

In the tests, no corrosion or no significant corrosion occurred on the aluminum samples tested.

TABLE 1

| | | | Table 2, Exam- |
|---|---|---|---|
| | | Example 2: | ple 2 from (6) |
| | | 60% by vol. of | (for comparison): |
| | | 1,3-propanediol | 60% by vol. of |
| | Example 1: | 40% by vol. of | monoethylene |
| | 60% by vol. of | water 0.1% | glycol 40% by |
| | 1,3-propanediol | by wt. of | vol. of water |
| | 40% by vol. | benzotriazole | 0.1% by wt. of |
| | of water | 742 ppm by | benzotriazole 742 |
| Coolant | 0.1% by wt. of | wt. of | ppm by wt. of |
| composition: | benzotriazole | tetraethoxysilane | tetraethoxysilane |
| Electrical | | | |
| conductivity | | | |
| [μS/cm] | | | |
| Beginning of test: | 2.9 | 3.4 | 3.2 |
| after 7 days: | 3.4 | 3.3 | 5.6 |
| after 14 days: | 3.4 | 3.1 | 5.2 |
| after 21 days: | 3.5 | 3.3 | |
| after 28 days: | 3.3 | 2.8 | 6.9 |
| pH | | | |
| Beginning of test: | 5.3 | 5.5 | 5.0 |
| End of test: | 4.5 | 4.6 | 4.9 |
| Appearance of | virtually | virtually | virtually |
| aluminum | unchanged | unchanged | unchanged |
| samples after | | | (end of test: |
| the test: | | | 77 days) |
| Weight change | | | |
| [mg/cm²] | | | |
| after pickling: | | | |
| 1 | −0.01 | ±0.00 | −0.02 |
| 2 | −0.01 | −0.01 | −0.02 |
| 3 | −0.01 | −0.01 | −0.04 |
| 4 | −0.01 | −0.01 | −0.04 |
| 5 | −0.03 | −0.03 | −0.04 |
| Mean value of | −0.01 | −0.01 | −0.03 |
| the samples | | | |
| Solution after | colorless, | colorless, | colorless, |
| end of test | clear | clear | clear |

In the mixture of 1,3-propanediol and water, the volume ratio of 60:40 corresponds to a weight ratio of 62.5:37.5.
In the novel example 2, the ortho-silicic ester was metered so that a silicon content of 100 ppm by weight was present in the cooling liquid.

1. An antifreeze concentrate for cooling systems in fuel cell drives, from which ready-to-use aqueous coolant compositions having a conductivity of not more than 50 μS/cm, which substantially comprise
(a) from 10 to 90% by weight of 1,3-propanediol or mixtures of 1,3-propanediol with alkylene glycols and/or derivates thereof,
(b) from 90 to 10% by weight of water,
(c) from 0.005 to 5% by weight of one or more five-membered heterocyclic compounds (azole derivatives) having 2 or 3 hetero atoms from the group consisting of nitrogen and sulfur, which contain no sulfur atom or not more than one sulfur atom and which may carry an aromatic or saturated six-membered fused moiety and
(d) if required, ortho-silicic esters,
result by dilution with ion-free water.

2. An antifreeze concentrate for cooling systems in fuel cell drives as claimed in claim 1, containing altogether from 0.05 to 5% by weight of the azole derivatives.

3. An antifreeze concentrate for cooling systems in fuel cell drives as claimed in claim 1, containing, as azole derivatives, benzimidazole, benzotriazole, tolutriazole, 1H-1,2,4-triazole and/or hydrogenated tolutriazole.

4. An antifreeze concentrate for cooling systems in fuel cell drives as claimed in claim 1, containing, in addition to the azole derivatives, ortho-silicic esters, from which ready-to-use aqueous coolant compositions having a silicon content of from 2 to 2 000 ppm by weight result.

5. A ready-to-use aqueous coolant composition for cooling systems in fuel cell drives, which substantially comprises
(a) from 10 to 90% by weight of 1,3-propanediol or mixtures of 1,3-propanediol with alkylene glycols and/or derivatives thereof,
(b) from 90 to 10% by weight of water,
(c) from 0.005 to 5% by weight of the azole derivatives and
(d) if required, ortho-silicic esters,
obtainable by dilution of an antifreeze concentrate as claimed in any of claims 1 to 4 with ion-free water.

6. The use of five-membered heterocyclic compounds (azole derivatives) having 2 or 3 hetero atoms from the group consisting of nitrogen and sulfur, which contain no sulfur atom or not more than one sulfur atom and which may carry an aromatic or saturated six-membered fused moiety, for the preparation of antifreeze concentrates for cooling systems in fuel cell drives, based on 1,3-propanediol or mixtures of 1,3-propanediol with alkylene glycols and/or derivatives thereof.

7. The use of an antifreeze concentrate as claimed in claim 6 for the preparation of ready-to-use aqueous coolant compositions having a conductivity of not more than 50 μS/cm for cooling systems in fuel cell drives.
